(19) United States
(12) Patent Application Publication
(10) Pub. No.: US 2013/0170423 A1
(43) Pub. Date: Jul. 4, 2013

(54) INTERFERENCE REDUCTION METHOD AND RADIO BASE STATION

(71) Applicants: Tetsushi Abe, Tokyo (JP); Zubin Bharucha, Tokyo (JP); Auer Gunther, Tokyo (JP)

(72) Inventors: Tetsushi Abe, Tokyo (JP); Zubin Bharucha, Tokyo (JP); Auer Gunther, Tokyo (JP)

(73) Assignee: NTT DOCOMO, INC., Tokyo (JP)

(21) Appl. No.: 13/704,255

(22) PCT Filed: Jun. 17, 2011
(86) PCT No.: PCT/JP2011/063946

§ 371 Date: Mar. 22, 2013

(30) Foreign Application Priority Data
Jun. 21, 2010 (JP) 2010-141063

(51) Int. Cl. H04W 72/04

(52) U.S. Cl. CPC H04W 72/0426
USPC 370/312; 455/452.1

(57) ABSTRACT

In a radio communication system in which a micro cell is provided in a macro cell, when a user terminal that is connected to the macro base station is located in the micro cell, interference signals which the user terminal receives from the micro base station are reduced. With the interference reduction method of the present invention, a user terminal UE that is connected to a macro base station (eNB) forming a macro cell transmits interference information indicating the interference signal power which the user terminal (UE) receives from a micro base station (HeNB) forming a micro cell, to the macro base station (eNB), when the interference signal power indicated by the interference information meets a predetermined condition, the macro base station (eNB) reports that to the micro base station (HeNB), and, in response to the report from the macro base station (eNB), the micro base station (HeNB) transmits data using a transmission frame in which interference signals from the micro base station (HeNB) at the user terminal (UE) can be reduced.

### TECHNICAL FIELD

The present invention relates to an interference reduction method and a radio base station in a radio communication system in which a micro cell is provided in a macro cell.

### BACKGROUND ART

The standards organization 3GPP sets forth a radio communication system (hereinafter referred to as “LTE system”) to use the LTE (Long Term Evolution) scheme, which is the successor of the UMTS (Universal Mobile Telecommunications System) scheme. Presently, 3GPP is also studying a radio communication system (hereinafter referred to as “LTE-A system”) to use the LTE-Advanced scheme, which is the successor of the LTE scheme.

Also, with respect to the LTE system and the LTE-A system, a radio communication system to place a micro cell (for example, a femto cell, a pico cell and so on), which has a local coverage area of a radius of approximately several tens of meters, in a macro cell having a wide coverage area of a radius of approximately several kilometers, is under study (see, for example, non-patent literature 1). This radio communication system is also referred to as “HetNet” (Heterogeneous Network).

### CITATION LIST

### Non-Patent Literature

Non-Patent Literature 1: 3GPP, TS22.220 v.9.4.0

### SUMMARY OF INVENTION

### Technical Problem

However, in the above-described radio communication system, there is a problem that, when a user terminal that is connected to the radio base station that forms the macro cell (hereinafter referred to as “macro base station”) is located in the micro cell, this user terminal receives increased interference signals from the radio base station forming the micro cell (hereinafter referred to as “micro base station”).

The present invention has been made in view of the above, and it is therefore an object of the present invention to provide an interference reduction method and a radio base station, whereby, when, in a radio communication system in which a micro cell is provided in a macro cell, a user terminal that is connected to the macro base station is located in the micro cell, the interference signals which the user terminal receives from the micro base station can be reduced.

### Solution to Problem

The interference reduction method according to the first aspect of the present invention is an interference reduction method in a radio communication system in which a micro cell is provided in a macro cell, and has: an interference information transmission step, in which a user terminal that is connected to a macro base station, which is a radio base station forming the macro cell, transmits interference information indicating interference signal power which the user terminal receives from a micro base station, which is a radio base station forming the micro cell, to the macro base station; a reporting step in which, when the interference signal power indicated by the interference information meets a predetermined condition, the macro base station reports that to the micro base station; and a data transmission step in which, in response to the report from the macro base station, the micro base station transmits data using a transmission frame in which interference signals from the micro base station at the user terminal can be reduced.

According to this configuration, when the interference signal power from the micro base station meets a predetermined condition at the user terminal that is connected to the macro base station (for example, when the user terminal is located in the micro cell and the interference signal power from the femto base station at this user terminal exceeds an allowable level), interference signals from the micro base station at the user terminal can be reduced, so that it is possible to prevent the user terminal from declaring an RLF (Radio Link Failure), which indicates that radio link detection with the macro base station has failed.

The radio base station according to a second aspect of the present invention is a radio base station forming a micro cell in a radio system in which the micro cell is provided in a macro cell, and has: a data transmission section that, when a report is received, from a macro base station, which is a radio base station forming the macro cell, that interference signal power which a user terminal that is connected to the macro base station receives meets a predetermined condition, transmits data using a transmission frame in which interference signals from the radio base station at the user terminal can be reduced.

The radio base station according to a third aspect of the present invention is a radio base station forming a macro cell in a radio system in which a micro cell is provided in the macro cell, and has: an acquiring section that acquires, from a user terminal that is connected to the radio base station, interference information indicating interference signal power which the user terminal receives from a micro base station, which is a radio base station forming the micro cell; and a reporting section that, when the interference signal power indicated by the interference information meets a predetermined condition, reports that to the micro base station.

### Advantageous Effects of Invention

According to the present invention, it is possible to provide an interference reduction method and a radio base station, whereby, when, in a radio communication system in which a micro cell is provided in a macro cell, a user terminal that is connected to the macro base station is located in the micro cell, the interference signals which the user terminal receives from the micro base station can be reduced.

### BRIEF DESCRIPTION OF DRAWINGS

FIG. 1 is a conceptual diagram of an HetNet;

FIG. 2 is a sequence diagram for explaining an interference reduction method according to the present invention;

FIG. 3 is a diagram for explaining the first operation mode of a femto base station HeNB;

FIG. 4 is a diagram for explaining a second operation mode of a femto base station HeNB;

FIG. 5 is diagram for explaining a third operation mode of a femto base station HeNB;

FIG. 6 is a schematic configuration diagram of a radio communication system according to an embodiment of the present invention;

FIG. 7 is a schematic configuration diagram of a macro base station according to an embodiment of the present invention;

FIG. 8 is a schematic configuration diagram of a user terminal according to an embodiment of the present invention;

FIG. 9 is a functional configuration diagram of a macro base station according to an embodiment of the present invention;

FIG. 10 is a functional configuration diagram of a femto base station according to an embodiment of the present invention; and

FIG. 11 is a functional configuration diagram of a user terminal according to an embodiment of the present invention.

### DESCRIPTION OF EMBODIMENTS

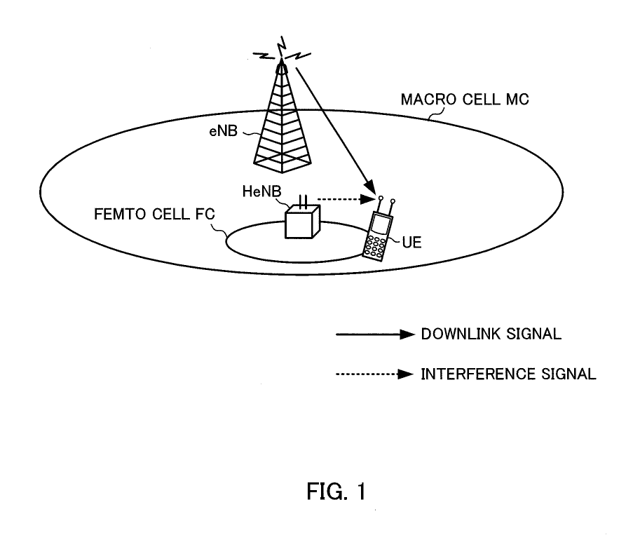

FIG. 1 is a conceptual diagram of a HetNet. Note that, with FIG. 1, an example will be described where a femto cell is used as a micro cell having a local coverage area. However, the micro cell may be any cell (for example, a pico cell) as long as it is provided in a macro cell and has a local coverage area.

As shown in FIG. 1, in an HetNet, a femto cell FC having a local coverage area is placed in a macro cell MC having a wide coverage area. In this way, by placing the femto cell FC in part of the macro cell MC (for example, in a place where the signal environment is poor, such as the inside of buildings), it is possible to improve throughput.

Also, in the HetNet shown in FIG. 1, the radio base station eNB (evolved NodeB) forming the macro cell MC (hereinafter referred to as “macro base station”) and the radio base station HeNB (Home evolved NodeB) forming the femto cell FC (hereinafter referred to as “femto base station”) share at least part of the frequency band. Consequently, when a user terminal UE that is connected to the macro base station eNB is located in the femto cell FC, the interference signals which the user terminal UE receives from the femto base station HeNB increase.

In this case, it may be possible that the user terminal UE carries out a handover from the macro base station eNB to the femto base station HeNB, and, by this means, avoids the interference signals to receive from the femto base station HeNB. However, when the user terminal UE is not allowed connection to the femto base station HeNB, such as when the user terminal UE does not belong to the CSG (Closed Subscriber Group) of the femto base station HeNB, the user terminal UE is unable to carry out a handover from the macro base station eNB to the femto base station HeNB. Consequently, cases occur where the user terminal UE is not able to avoid interference signals from the femto base station HeNB and declares an RLF (Radio Link Failure), which indicates that radio link detection with the macro base station eNB to which the user terminal belongs has failed.

The present inventors have arrived at the present invention by focusing on the fact that cases occur where, as described above, when a user terminal UE that is connected to a macro base station eNB is located in a femto cell FC, the user terminal UE declares an RLF, due to interference signals received from the femto base station HeNB.

With the interference reduction method according to the present invention, a user terminal UE that is connected to a macro base station eNB forming a macro cell MC transmits interference information to indicate the interference signal power received from a femto base station HeNB (micro base station) forming a femto cell FC (micro cell), to the macro base station eNB. When the interference signal power indicated by this interference information meets a predetermined condition, the macro base station eNB reports this to the femto base station HeNB. In response to the report from the macro base station eNB, the femto base station HeNB shifts to a fallback mode to transmit data using a transmission frame in which interference signals from the femto base station HeNB at the user terminal UE can be reduced. In particular, in response to the report from the macro base station eNB, the femto base station HeNB decides whether or not the user terminal UE is allowed connection to the femto base station HeNB, and, when this connection is not allowed (for example, when the user terminal UE does not belong to the CSG of the femto base station HeNB), the femto base station HeNB shifts to the fallback mode.

With the interference reduction method according to the present invention, when the interference signal power from a femto base station HeNB meets a predetermined condition at a user terminal UE that is connected to a macro base station eNB, that is, when a user terminal UE is located in a femto cell FC, interference signals from the femto base station HeNB at the user terminal UE can be reduced, so that it is possible to prevent this user terminal UE from declaring an RLF which indicates that radio link detection with the macro base station eNB has failed. In particular, even when the user terminal UE is not allowed connection to the femto base station HeNB and is unable to carry out a handover to the femto base station HeNB, it is possible to reduce interference signals from the femto base station HeNB at the user terminal UE, so that it is possible to prevent, more effectively, the user terminal UE from declaring an RLF.

Now, the interference reduction method according to the present invention will be described below. The interference reduction method according to the present invention is carried out when a user terminal UE that is connected to a macro base station eNB is located in a femto cell FC.

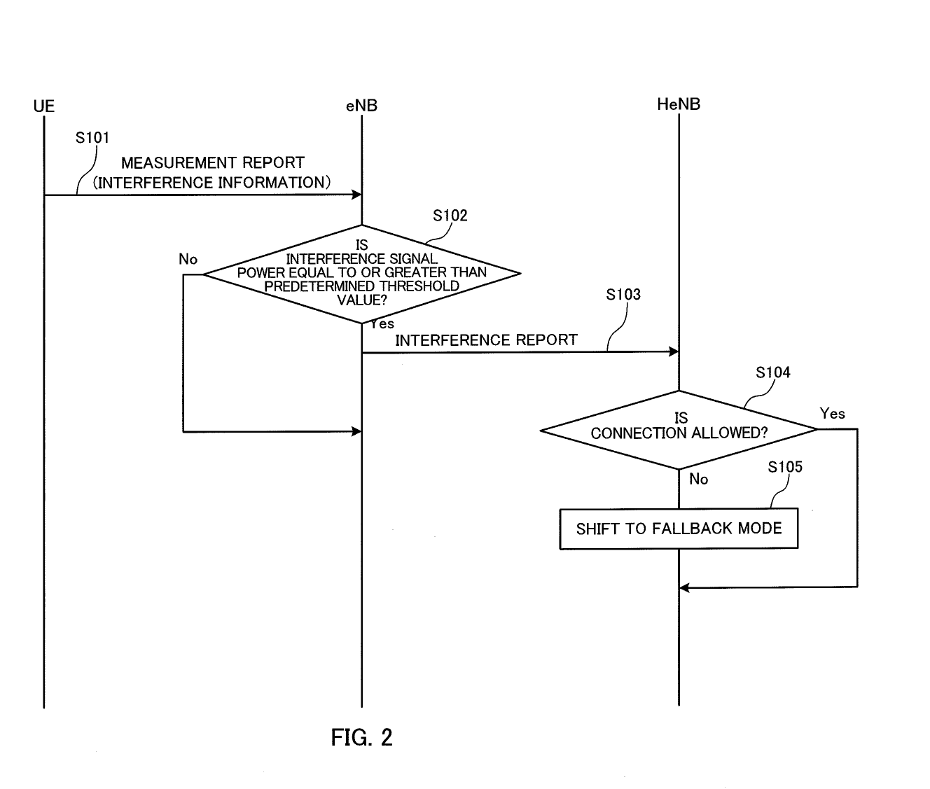

FIG. 2 is a sequence diagram for explaining the interference reduction method according to the present invention. As shown in FIG. 2, with the interference reduction method according to the present invention, a user terminal UE transmits a measurement report including interference information, to the macro base station eNB to which the user terminal UE is connected (step S101). Here, the interference information indicates the interference signal power from a femto base station HeNB at the user terminal UE, and is, for example, the RS-SIR (Reference Signal Signal-to-Interference Ratio), the RSRP (Reference Signal Received Power), the RSSI (Received Signal Strength Indicator), the RSRQ (Reference Signal Received Quality), and so on. Note that the user terminal UE may also transmit the above interference information to the macro base station eNB by other signals than the measurement report (for example, a handover request signal).

Based on the measurement report from the user terminal UE, the macro base station eNB decides whether or not the interference signal power from the femto base station HeNB at the user terminal UE meets a predetermined condition (step S102). The predetermined condition here is a condition to indicate that the interference signal power from the femto base station HeNB exceeds an allowable level at the user terminal UE, and is, for example, the condition that the interference signal power from the femto base station HeNB is equal to or greater than a predetermined threshold value. When the interference signal power from the femto base station HeNB at the user terminal UE meets the predetermined condition (step S102: Yes), the macro base station eNB transmits an interference report to indicate that, to the femto base station HeNB (step S103). Note that the macro base station eNB may also transmit an interference report to the femto base station HeNB using an S1 interface or an X2 interface, which will be described later.

In response to the interference information from the macro base station eNB, the femto base station HeNB decides whether or not the user terminal UE is allowed connection to the femto base station HeNB (step S104). For example, the femto base station HeNB decides whether or not the user terminal UE belongs to the CSG of the femto HeNB.

When the femto base station HeNB decides that the user terminal UE is not allowed connection to the femto base station HeNB (step S104: No), the femto base station HeNB shifts to a fallback mode (step S105).

Here, the fallback mode is a mode in which the femto base station HeNB transmits data using a transmission frame in which interference signals from the femto base station HeNB at the user terminal UE can be reduced. Now, the operation mode of the femto base station HeNB in the fallback mode will be described in detail below.

As will be described below, the femto base station HeNB in the fallback mode has the first to third operation modes. Note that, in the first and second operation modes, the femto base station HeNB reduces interference signals against the user terminal UE by providing blank periods, in which no data transmission or little data transmission is carried out, in a transmission frame. Meanwhile, in the third operation mode, the femto base station HeNB reduces interference signals against the user terminal UE by providing transmission power reduction periods, in which transmission power is reduced lower than in other periods, in a transmission frame.

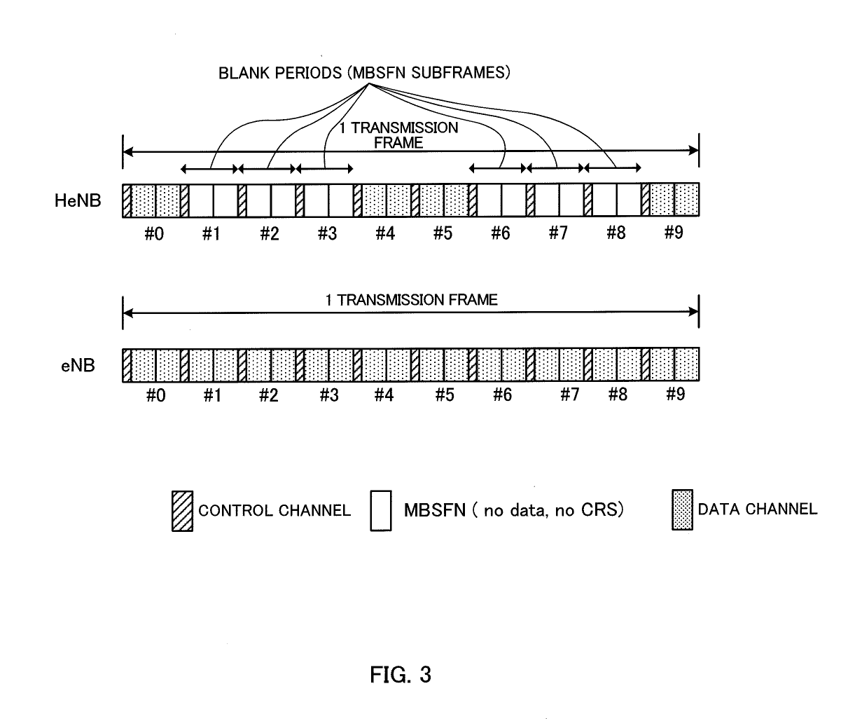

FIG. 3 is a diagram for explaining the first operation mode of the femto base station HeNB in the fallback mode. As shown in FIG. 3, by applying MBSFN (Multimedia Broadcast multicast service Single Frequency Network) subframes to specific subframes in a transmission frame, the femto base station HeNB provides blank periods in this transmission frame.

Here, an MBSFN subframe is a subframe which, in one subframe that is formed with a control channel time field and a data channel time field, can be set not to carry out data transmission using the data channel time field.

In FIG. 3, the femto base station HeNB applies MBSFN subframes to subframes #1 to #3 and #6 to #8 in one transmission frame, thereby making subframes #1 to #3 and #6 to #8 blank periods.

Consequently, in the case shown in FIG. 3, even when the user terminal UE receives interference signals in subframes #0, #4, #5 and #9, to which MBSFN subframes are not applied in the femto base station HeNB, interference signals from the femto base station HeNB are not received much in subframes #1 to #3 and #6 to #8, to which MBSFN subframes are applied in the femto base station HeNB. As a result of this, it is possible to reduce the interference signals which the user terminal UE receives from the femto base station HeNB, so that it is possible to prevent the user terminal UE from declaring an RLF.

Note that, in a transmission frame from the femto base station HeNB, the subframes to which MBSFN subframes are applied are by no means limited to the example shown in FIG. 3. For example, MBSFN subframes may be applied every other subframe in a transmission frame.

As described above, according to the first operation mode of the femto base station HeNB, the femto base station HeNB applies MBSFN subframes to specific subframes in a transmission frame from the femto base station HeNB, so that it is possible to provide periods in which the interference signals which the user terminal UE receives from the femto base station HeNB can be reduced, and prevent the user terminal UE from declaring an RLF.

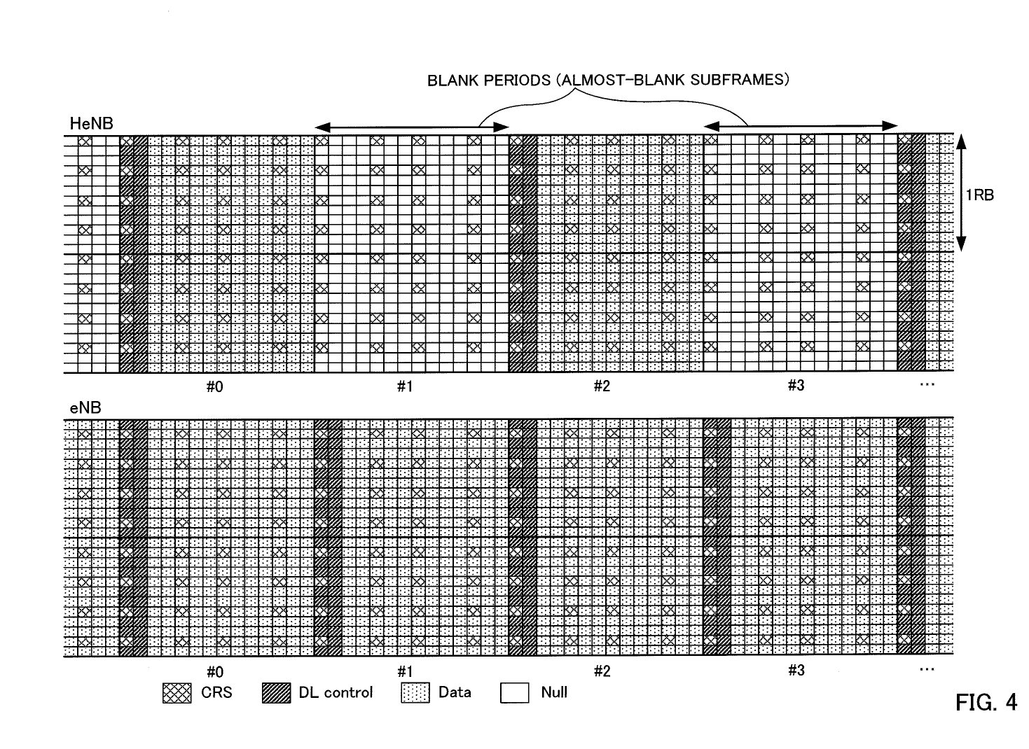

FIG. 4 is a diagram for explaining the second operation mode of the femto base station HeNB in the fallback mode. As shown in FIG. 4, the femto base station HeNB provides blank periods in a transmission frame by applying almost-blank subframes to specific subframes in a transmission frame from the femto base station HeNB.

Here, an almost-blank subframe is a subframe which can be set to transmit only the CRS (Common Reference Signal) and not to transmit other data.

In FIG. 4, the femto base station HeNB makes subframes #1 and #3 blank periods by applying almost-blank subframes every other subframe in one transmission frame, that is, by applying almost-blank subframes to subframes #1 and #3.

Consequently, in the case shown in FIG. 4, even when interference signals are received in subframes #0, #2 and so on, to which almost-blank subframes are not applied in the femto base station HeNB, in subframes #1, #3 and so on, to which almost-blank subframes are applied in the femto base station HeNB, the user terminal UE does not receive interference signals much from the femto base station HeNB. As a result of this, it is possible to reduce the interference signals which the user terminal UE receives from the femto base station HeNB, and prevent the user terminal UE from declaring an RLF.

Note that, in a transmission frame from the femto base station HeNB, the subframes to which almost-blank subframes are applied are by no means limited to the example shown in FIG. 4. For example, it is equally possible to apply almost-blank subframes to consecutive subframes in a transmission frame.

As described above, according to the second operation mode of the femto base station HeNB, the femto base station HeNB applies almost-blank subframes to specific subframes in a transmission frame from the femto base station HeNB, so that it is possible to provide periods in which the interference signals which the user terminal UE receives from the femto base station HeNB can be reduced, and prevent the user terminal UE from declaring an RLF.

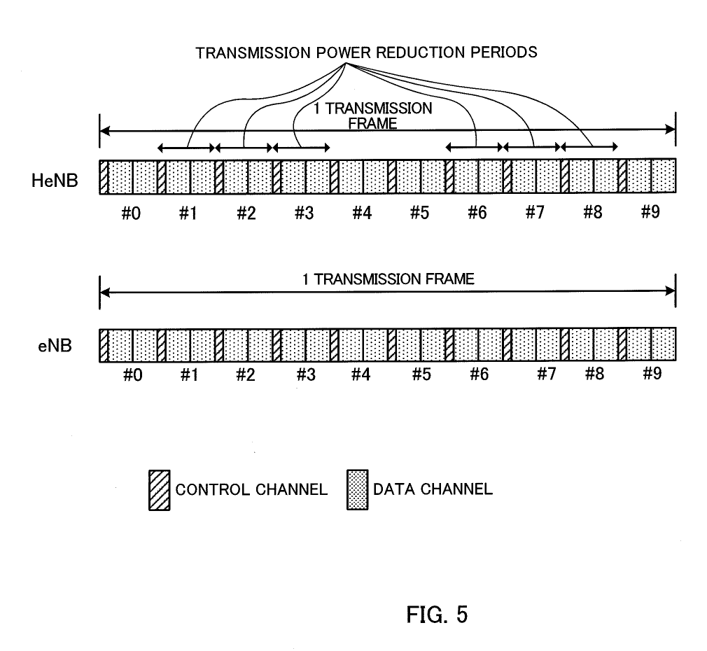

FIG. 5 is a diagram for explaining the third operation mode of the femto base station HeNB in the fallback mode. As shown in FIG. 5, the femto base station HeNB provides transmission power reduction periods in a transmission frame from the femto base station HeNB.

Here, a transmission power reduction period is a period in which transmission power is reduced lower than in other subframes that transmit the same amount of data, and is applied to a specific subframe in one transmission frame.

In FIG. 5, in subframes #1 to #3 and #6 to #8 in one transmission frame, the femto base station HeNB carries out data transmission in both the control channel time field and the data channel time field, as in subframes #0, #4, #5 and #9. Furthermore, the femto base station HeNB makes subframes #1 to #3 and #6 to #8 be transmission power reduction periods in which the transmission power of subframes #1 to #3 and #6 to #8 is reduced lower than the transmission power of subframes #0, #4, #5 and #9.

Consequently, in the case shown in FIG. 5, even when interference signals are received in subframes #0, #4, #5 and #9, in which the transmission power at the femto base station HeNB is not reduced, the user terminal UE is able to reduce the influence of interference signals from the femto base station HeNB, in subframes #1 to #3 and #6 to #8, in which the transmission power at the femto base station HeNB is reduced. As a result of this, it is possible to reduce the interference signals which the user terminal UE receives from the femto base station HeNB, so that it is possible to prevent the user terminal UE from declaring an RLF.

Note that, in a transmission frame from the femto base station HeNB, the specific subframes in which transmission power is reduced are by no means limited to the example shown in FIG. 5. For example, in a transmission frame, the subframes in which transmission power is reduced lower than in other subframes may be provided every other subframe.

As described above, according to the third operation mode of the femto base station HeNB, the femto base station HeNB provides transmission power reduction periods in specific subframes in a transmission frame from the femto base station HeNB, so that it is possible to provide periods in which the interference signals which the user terminal UE receives from the femto base station HeNB can be reduced, and prevent the user terminal UE from declaring an RLF.

Now, an embodiment of the present invention will be described below in detail with reference to the accompanying drawings. Here, a case of using base stations and a user terminal supporting the LTE-A system will be described.

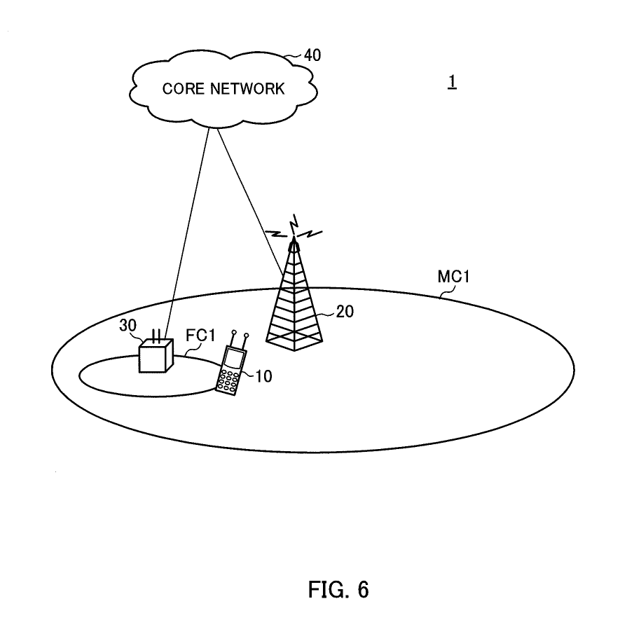

FIG. 6 is a diagram for explaining a configuration of a radio communication system 1 having a user terminal (UE) 10, a macro base station (eNB) 20, and a femto base station (HeNB) 30 according to an embodiment of the present invention. Note that the radio communication system 1 illustrated in FIG. 6 is a system to accommodate, for example, the LTE system or SUPER 3G. Also, this radio communication system 1 may be referred to as “IMT-Advanced” or may be referred to as “4G.”

Also, the radio communication system 1 shown in FIG. 6 is a system to use a HetNet. A case will be described with the radio communication system 1 where a femto cell is used as a micro cell having a local coverage area. However, it is equally possible to use other cells that have a local coverage, such as a pico cell, as a micro cell.

As shown in FIG. 6, the radio communication system 1 includes a user terminal 10, a radio base station 20 forming a macro cell MC 1 (hereinafter referred to as “macro base station”), and a radio base station 30 forming a femto cell FC 1 in the macro cell MC 1 (hereinafter referred to as “femto base station”). The macro base station 20 and the femto base station 30 are connected to a core network 40, and communicate with upper station apparatuses (for example, an MME (Mobility Management Entity), a gateway apparatus, and so on) provided in the core network 40. Also, in the macro base station 20 and the femto base station 30, by a scheduler, radio resources are allocated, in resource block units, per user terminal 10.

In the radio communication system 1, as radio access schemes, OFDMA (Orthogonal Frequency Division Multiple Access) is applied to the downlink, and SC-FDMA (Single-Carrier Frequency-Division Multiple Access) is applied to the uplink. OFDMA is a multi-carrier transmission scheme to perform communication by dividing a frequency band into a plurality of narrow frequency bands (subcarriers) and mapping data to each subcarrier. SC-FDMA is a single carrier transmission scheme to reduce interference between terminals by dividing, per terminal, the system band into bands formed with one or continuous resource blocks, and allowing a plurality of terminals to use mutually different bands.

Now, the communication channels to be used in the radio communication system 1 will be described. The downlink communication channels include the PDSCH, which serves as a downlink data channel to be shared by each user terminal 10, downlink L1/L2 control channels (PDCCH and so on), and a broadcast channel (BCH). User data and uplink control information are transmitted by the PDSCH. Scheduling information of the PDSCH and the PUSCH and so on, are transmitted by the PDCCH. The uplink communication channels include the PUSCH (Physical Uplink Shared CHannel), which serves as an uplink data channel to be shared by each user terminal 10, and the PUCCH (Physical Uplink Control CHannel), which serves as an uplink control channel. User data and uplink control information are transmitted by the PUSCH. The above-described measurement report is transmitted by the PUSCH.

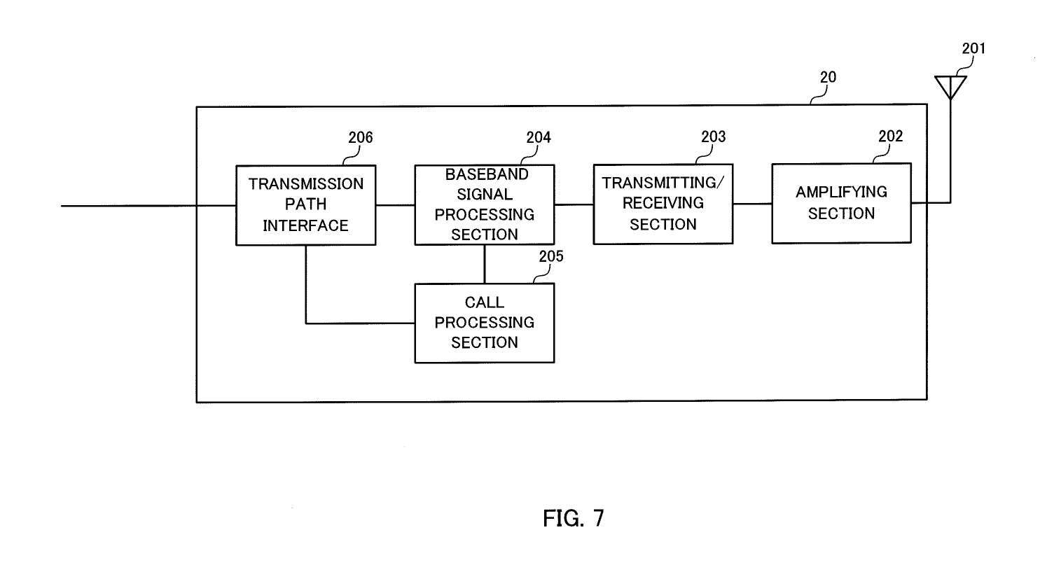

FIG. 7 is a schematic configuration diagram of a macro base station 20 according to the present embodiment. As illustrated in FIG. 7, the base station 20 has a transmitting/receiving antenna 201, an amplifying section 202, a transmitting/receiving section 203, a baseband signal processing section 204, a call processing section 205, and a transmission path interface 206. Note that the femto base station 30 has the same configuration as the macro base station 20 shown in FIG. 7 (that is, has a transmitting/receiving antenna 301, an amplifying section 302, a transmitting/receiving section 303, a baseband signal processing section 304, a call processing section 305, and a transmission path interface 306). Although the configuration of the macro base station 20 will be described below, the same applies to the femto base station 30.

The transmission path interface 206 is a communication interface with an upper station apparatus (not shown) provided in the core network 40. The transmission path interface 206 inputs downlink data that is received from the upper station apparatus (not shown), in the baseband signal processing section 204. Also, the transmission path interface 206 transmits uplink data that is input from the baseband signal processing section 204, to the upper station apparatus (not shown). Also, the transmission path interface 206 receives an interference report that is transmitted from the macro base station 20 to the femto base station 30, from the upper station apparatus (not shown), via the core network 40. Communication between the macro base station 20 and the femto base station 30 may be carried out using an S1 interface or an X2 interface. Here, the S1 interface connects the macro base station 20 and the femto base station 30, via an MME (Mobility Management Entity) (not shown) and an S-GW (S-GateWay) provided in the core network 40. Also, the X2 interface connects the macro base station 20 and the femto base station 30 directly, and is newly defined.

The baseband signal processing section 204 applies baseband signal processing, including a scheduling process, an error correction coding process, and an IFFT (Inverse Fast Fourier Transform) process, to the downlink data that is input from the transmission path interface 206, and inputs the baseband signal acquired by the baseband signal processing, to the transmitting/receiving section 203. Also, the baseband signal processing section 204 applies baseband signal processing, including an FFT (Fast Fourier Transform) process and an error correction decoding process, to the baseband signal that is input from the transmitting/receiving section 203, and inputs the uplink data acquired by the baseband signal processing, to the transmission path interface 206

The transmitting/receiving section 203 performs frequency conversion of the baseband signal that is output from the baseband signal processing section 204, into a radio frequency band, and outputs the frequency-converted downlink transmission signal via the amplifier 202 and the transmitting/receiving antenna 201. Also, the transmitting/receiving section 203 performs frequency conversion of the uplink received signal that is received via the transmitting/receiving antenna 201 and the amplifier 202, and inputs the baseband signal in the baseband signal processing section 204.

The call processing section 205 performs call processing such as setting up and releasing calls of the user terminal 10.

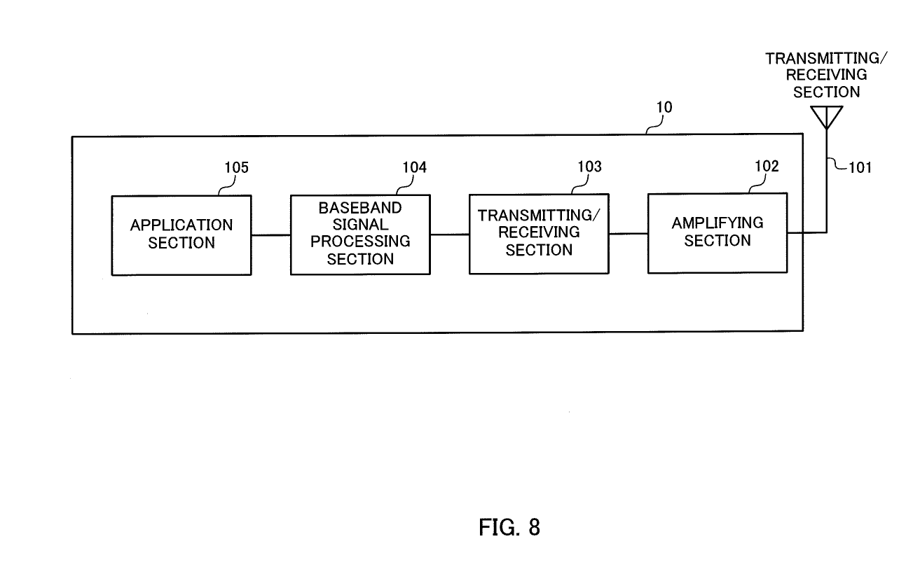

FIG. 8 is a schematic configuration diagram of a user terminal 10 according to the present embodiment. The user terminal 10 has a transmitting/receiving antenna 101, an amplifying section 102, a transmitting/receiving section 103, a baseband signal processing section 104 and an application section 105.

The transmitting/receiving section 103 performs frequency conversion of the baseband signal that is output from the baseband signal processing section 104, into a radio frequency band, and transmits a frequency-converted uplink transmission signal via the amplifier 102 and the transmitting/receiving antenna 101. Also, the transmitting/receiving section 103 performs frequency conversion of the downlink received signal that is received via the transmitting/receiving antenna 101 and the amplifier 102, and inputs the baseband signal in the baseband signal processing section 104.

The baseband signal process 104 applies baseband signal processing, including a scheduling process, an error correction coding process, and an IFFT (Inverse Fast Fourier Transform) process, to uplink data that is input from the application section 105, and inputs the baseband signal acquired from the baseband signal processing, to the transmitting/receiving section 103. Also, the baseband signal processing section 104 applies baseband signal processing, including an FFT (Fast Fourier Transform) process and an error correction decoding process, to the baseband signal that is input from the transmitting/receiving section 103, and inputs downlink data that is acquired by the baseband signal processing, in the application section 105.

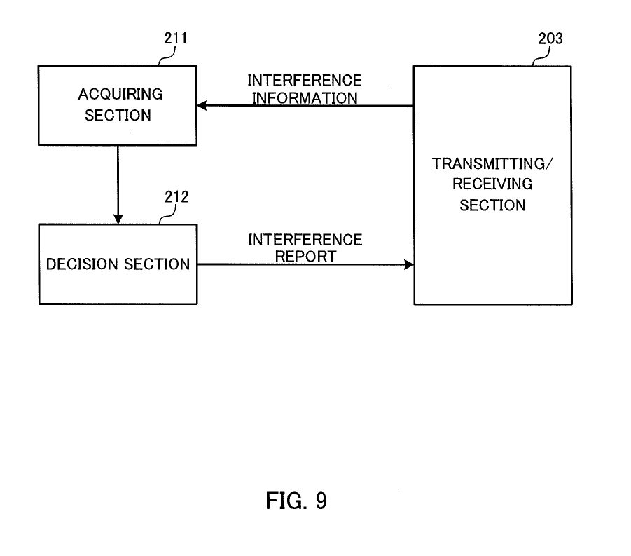

FIG. 9 is a functional configuration diagram of a macro base station 20 according to the present embodiment. As shown in FIG. 9, the macro base station 20 has an acquiring section 211 and a decision section 212 as functional configurations for interference report process to the femto base station 30. The functional configurations are mainly realized by the baseband signal processing section 204 of FIG. 7, but may as well be realized by hardware such as a processor, a memory and so on, or software modules, that are not shown in FIG. 7.

When the user terminal 10 that is connected to the macro base station 20 is located in the femto cell FC 1, the acquiring section 211 acquires interference information from the femto base station 30 at the user terminal 10. Here, as described above, the interference information is information that indicates the interference signal power from the femto base station 30 at the user terminal 10. Also, the interference information may be included in the measurement report from the user terminal 10, received by the transmitting/receiving section 203, or may be included in other signals (for example, a handover request) from the user terminal 10, received by the transmitting/receiving section 203.

The decision section 212 (reporting section) decides, based on the interference information acquired by the acquiring section 211, whether or not the interference signal power from the femto base station 30 meets a predetermined condition at the user terminal 10. Note that the predetermined condition here is a condition to indicate that the interference signal power from the femto base station HeNB at the user terminal UE exceeds an allowable level, and is, for example, the condition that the interference signal power from the femto base station HeNB is equal to or greater than a predetermined threshold value. When the decision section 212 decides that the interference signal power from the femto base station 30 at the user terminal 10 meets the predetermined condition, the decision section 212 transmits an interference report indicating that, to the femto base station 30, via the transmitting/receiving section 203.

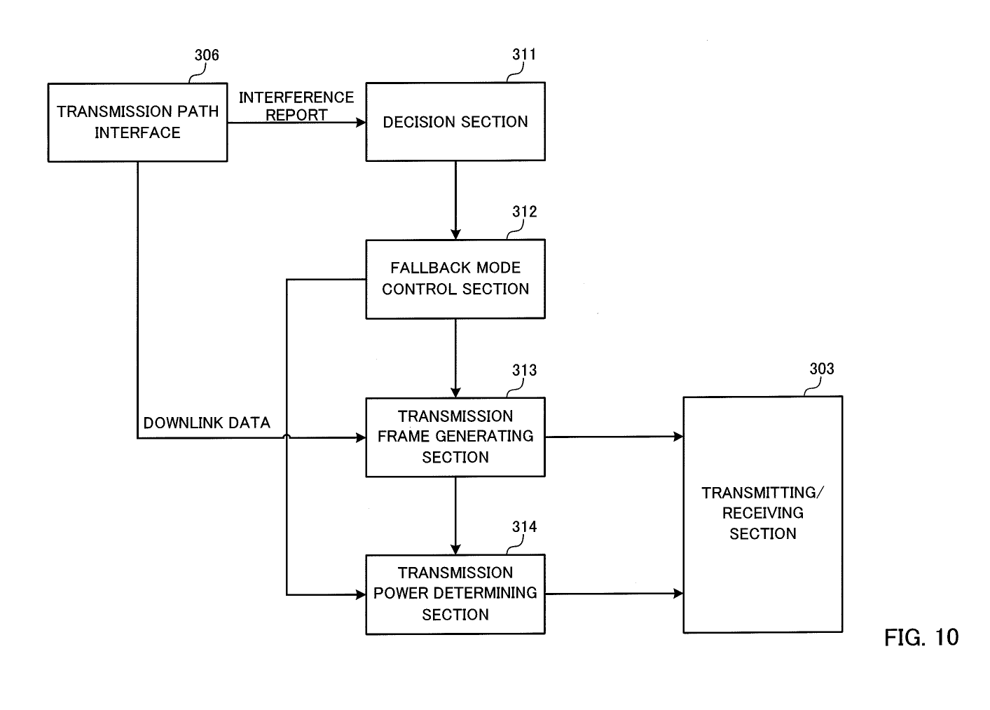

FIG. 10 is a functional configuration diagram of the femto base station 30 according to the present embodiment. As shown in FIG. 10, the femto base station 30 has a decision section 311, a fallback mode control section 312, a transmission frame generating section 313 and a transmission power determining section 314, as functional configurations for the process of reducing interference against the user terminal 10. The functional configurations are mainly realized by the baseband signal processing section 304, but may as well be realized by hardware such as a processor, a memory and so on, or software modules.

When the interference report from the macro base station 20 is received by the transmission path interface 306, the decision section 311 decides whether or not the user terminal 10 pertaining to this report is allowed connection to the femto base station 30. For example, when the user terminal 10 pertaining to this report belongs to the CSG (Closed Subscriber Group) of the femto base station 30, the decision section 311 decides that the user terminal 10 is allowed connection to the femto base station 30 when the user terminal 10.

When the decision section 311 decides that the user terminal 10 is allowed connection to the femto base station 30, the fallback mode control section 312 makes the femto base station 30 shift to the fallback mode for reducing interference signals against the user terminal 10.

To be more specific, the fallback mode control section 312 may command the transmission frame generating section 313 to provide blank periods in a transmission frame, in the fallback mode. Also, the fallback mode control section 312 may command the transmission frame generating section 313 to reduce the transmission power of specific subframes in a transmission frame.

The transmission frame generating section 313 generates a transmission frame formed with a plurality of subframes. To be more specific, the transmission frame generating section 313 maps the downlink data received by the transmission path interface 306 to the data channel time field of each subframe, and maps control information for receiving this downlink data to the control channel time field of each subframe.

Also, the transmission frame generating section 313 may provide blank periods in a transmission frame in response to a command from the fallback mode control section 312. To be more specific, as has been described with reference to FIG. 3 and FIG. 4, by applying MBSFN subframes or almost-blank subframes to specific subframes in a transmission frame that is transmitted from the transmitting/receiving section 303, the transmission frame generating section 313 provides blank periods in this transmission frame.

The transmission power determining section 314 determines the transmission power of the transmission frame generated in the transmission frame generating section 313, per subframe. Also, the transmission power determining section 314 may provide transmission power reduction periods in a transmission frame in response to a command from the fallback mode control section 312. To be more specific, as has been described with reference to FIG. 5, the transmission power determining section 314 determines the transmission power of specific subframes in a transmission frame to be lower than the transmission power of other subframes.

The transmitting/receiving section 303 (data transmission section) transmits the transmission frame generated by the transmission frame generating section 313 by the transmission power determined by the transmission power determining section 314.

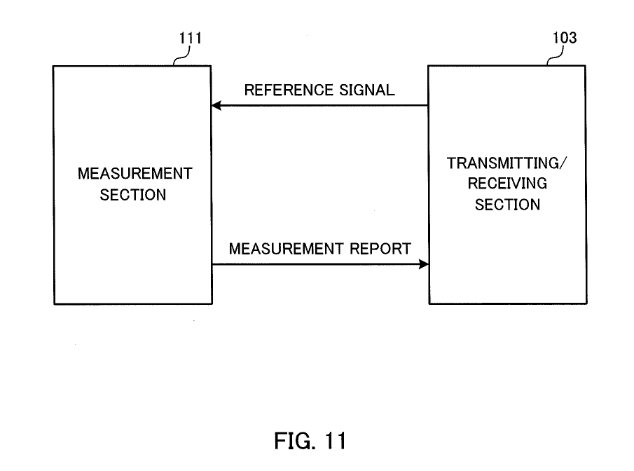

FIG. 11 is a functional configuration diagram of the user terminal 10 according to the present embodiment. As shown in FIG. 11, the user terminal 10 has a measurement section 111 as a functional configuration for the process of measuring interference from the femto base station 30. The functional configuration is mainly realized by the baseband signal processing section 104 of FIG. 8, but may as well be realized by hardware such as a processor, a memory and so on, or software modules, that are not shown in FIG. 8.

The measurement section 111 measures the interference signal power from the femto base station 30. To be more specific, the measurement section 111 measures the interference signal power from the femto base station 30 based on reference signals from the macro base station 20 and the femto base station 30, received by the transmitting/receiving section 103. To be more specific, as the interference signal power from the femto base station 30, the measurement section 111 measures the RS-SIR (Reference Signal Signal-to-Interference Ratio), which is the received power ratio between the reference signal from the macro base station 20 and the reference signal from the femto base station 30, the RSRP (Reference Signal Received Power), which is the received signal power from the femto base station 30, the RSSI (Received Signal Strength Indicator), which is the received signal power from the femto base station 30, the RSRQ (Reference Signal Received Quality), which is the received signal quality from the femto base station 30, and so on.

As described above, with the radio communication system according to the present embodiment, when the interference signal power from the femto base station 30 meets a predetermined condition at the user terminal 10 that is connected to the macro base station 20 (for example, when the user terminal 10 is located in the femto cell FC and the interference signal power from the femto base station 30 at the user terminal 10 exceeds an allowable level), interference signals from the femto base station 30 at the user terminal 10 can be reduced, so that it is possible to prevent the user terminal 10 from declaring an RLF, which indicates that radio link detection with the macro base station 20 has failed. In particular, even when the user terminal 10 is not allowed connection to the femto base station 30 and is unable to carry out a handover to the femto base station 30, it is possible to reduce interference signals from the femto base station 30 at the user terminal 10, so that it is possible to prevent, more effectively, the user terminal 10 from declaring an RLF.

Now, although the present invention has been described in detail with reference to the above embodiments, it should be obvious to a person skilled in the art that the present invention is by no means limited to the embodiment described in this specification. The present invention can be implemented with various corrections and in various modifications, without departing from the spirit and scope of the present invention defined by the recitations of the claims. Consequently, the descriptions in this specification are provided only for the purpose of explaining examples, and should by no means be construed to limit the present invention in any way.

The disclosure of Japanese Patent Application No. 2010-141063, filed on Jun. 21, 2010, including the specification, drawings, and abstract, is incorporated herein by reference in its entirety.

1. An interference reduction method in a radio communication system in which a micro cell is provided in a macro cell, the method comprising:
an interference information transmission step, in which a user terminal that is connected to a macro base station, which is a radio base station forming the macro cell, transmits interference information indicating interference signal power which the user terminal receives from a micro base station, which is a radio base station forming the micro cell, to the macro base station;
a reporting step in which, when the interference signal power indicated by the interference information meets a predetermined condition, the macro base station reports that to the micro base station; and
a data transmission step in which, in response to the report from the macro base station, the micro base station transmits data using a transmission frame in which interference signals from the micro base station at the user terminal can be reduced.

2. The interference reduction method according to claim 1, further comprising a decision step in which, in response to the report from the macro base station, the micro base station decides whether or not the user terminal is allowed connection to the micro base station,
wherein, in the decision step, when the user terminal is decided not to be allowed connection to the micro base station, in the data transmission step, the micro base station transmits the data using the transmission frame.

3. The interference reduction method according to claim 1, wherein the transmission frame has a blank period, in which no data or little data is transmitted.

4. The interference reduction method according to claim 3, wherein the transmission frame is an MBSFN (Multimedia Broadcast multicast service Single Frequency Network) subframe.

5. The interference reduction method according to claim 1, wherein the transmission frame has a transmission power reduction period, which is a period in which transmission power is reduced lower than in other periods.

6. The interference reduction method according to claim 1, wherein, in the reporting step, the macro base station reports that the interference signal power meets the predetermined condition, to the micro base station, using an S1 interface or an X2 interface.

7. A radio base station forming a micro cell in a radio system in which the micro cell is provided in a macro cell, the radio base station comprising a data transmission section that, when a report is received, from a macro base station, which is a radio base station forming the macro cell, that interference signal power which a user terminal that is connected to the macro base station receives meets a predetermined condition, transmits data using a transmission frame in which interference signals from the radio base station at the user terminal can be reduced.

8. The radio base station according to claim 7, further comprising a decision section that, when the report is received, from the macro base station, that the interference signal power meets the predetermined condition, decides whether or not the user terminal is allowed connection to the radio base station,
wherein, when the decision section decides that the user terminal is not allowed connection to the radio base station, the data transmission section transmits the data using the transmission frame.

9. The radio base station according to claim 7, wherein the transmission frame has a blank period, in which no data or little data is transmitted.

10. The radio base station according to claim 9, wherein the transmission frame is an MBSFN (Multimedia Broadcast multicast service Single Frequency Network) subframe.

11. The radio base station according to claim 7, wherein the transmission frame has a transmission power reduction period, which is a period in which transmission power is reduced lower than in other periods.

12. The radio base station according to claim 7, wherein the macro base station reports that the interference signal power meets the predetermined condition, using an S1 interface or an X2 interface.

13. A radio base station forming a macro cell in a radio system in which a micro cell is provided in the macro cell, the radio base station comprising:
an acquiring section that acquires, from a user terminal that is connected to the radio base station, interference information indicating interference signal power which the user terminal receives from a micro base station, which is a radio base station forming the micro cell; and
a reporting section that, when the interference signal power indicated by the interference information meets a predetermined condition, reports that to the micro base station.

14. The radio base station according to claim 13, wherein the reporting section reports that the interference signal power meets the predetermined condition, to the micro base station, using an S1 interface or an X2 interface.
